(19) United States
(12) Patent Application Publication
(10) Pub. No.: US 2025/0207309 A1
(43) Pub. Date: Jun. 26, 2025

(54) FUNCTIONALIZED FABRIC

(71) Applicant: Owens Corning Intellectual Capital, LLC, Toledo, OH (US)

(72) Inventors: David Blandin, La Ravoire (FR); Nadege Boucard, Le Pont de Beauvosin (FR); Julien Jouannaux, Chambery (FR)

(21) Appl. No.: 18/848,599

(22) PCT Filed: Mar. 23, 2023
(86) PCT No.: PCT/EP2023/057418

§ 371 Date: Sep. 19, 2024

(30) Foreign Application Priority Data
Mar. 23, 2022 (EP) 22305347.1

(51) Int. Cl. D04H 1/60; D04H 1/4218; D04H 1/52; D04H 1/74

(52) U.S. Cl. CPC D04H 1/60; D04H 1/4218; D04H 1/52; D04H 1/74; D10B 2505/02

(57) ABSTRACT

Herein is described a functionalized fabric comprising a fiber fabric and binder having a glass transition temperature of about 75° C. or less, wherein the binder constitutes up to about 5 wt. % of the functionalized fabric.

### FIELD OF THE INVENTION

The present invention relates to functionalized fabrics including glass fibers and/or carbon fibers, in particular functionalized fabrics to reinforce structural components such as wind turbine components.

### BACKGROUND

It is known to use glass and/or carbon fibers to form reinforcement fiber fabrics to reinforce structural components such as wind turbine blades or related components (e.g. spar caps).

Structural components containing reinforcement fiber fabrics (reinforced structural components) are often formed by stacking layers of reinforcement fiber fabrics in a mold, filling the mold with a resin, and curing the resin to form the component. This process can be time consuming.

Wind power and the use of wind turbines have gained increased attention as the quest for alternative energy sources continues. With increasing interests in generating more energy from wind power, technological advances in the art have allowed for increased sizes of wind turbine blades. Increasing the size of wind turbine blades also increases the time required to produce the wind turbine blades.

It would be desirable to provide improvements in efficiency of the production of reinforced structural components such as wind turbine blades.

### SUMMARY OF THE INVENTION

At its most general, the present invention provides a functionalized fabric comprising a fiber fabric and binder having a glass transition temperature of up to about 75° C., the binder constituting up to about 5 wt. % of the functionalized fabric.

In an aspect, the present invention provides a functionalized fabric comprising:
a fiber fabric; and
binder particles having a glass transition temperature of up to about 75° C.,
wherein the fiber fabric comprises:
first fibers oriented in a first direction; and
second fibers oriented in a second direction, the first fibers comprising glass fibers and/or carbon fibers, the second fibers comprising glass fibers and/or carbon fibers, and the second direction being within 0 to 90 degrees of the first direction,
   wherein the binder particles constitute up to about 5 wt. % (for example, from about 0.1 wt. % to about 3.5 wt. %) of the functionalized fabric, optionally the functionalized fabric comprising from about 2 to about 20 g/m² of the binder particles.

In an aspect, the present invention provides a functionalized fabric comprising:
a fiber fabric; and
binder particles having a glass transition temperature of up to about 75° C.,
wherein the fiber fabric comprises:
first fibers oriented in a first direction; and
second fibers oriented in a second direction, the first fibers comprising glass fibers and/or carbon fibers, the second fibers comprising glass fibers and/or carbon fibers, and the second direction being within 0 to 90 degrees of the first direction,
   wherein the binder particles constitute up to about 5 wt. % (for example, from about 0.1 wt. % to about 3.5 wt. %) of the functionalized fabric, the binder particles being adhered to a surface of the fiber fabric, optionally the functionalized fabric comprising from about 2 to about 20 g/m² of the binder particles.

In an aspect, the present invention provides a functionalized fabric comprising:
a fiber fabric; and
binder having a glass transition temperature of up to about 75° C.,
wherein the fiber fabric comprises: first fibers oriented in a first direction; and second fibers oriented in a second direction, wherein the first fibers comprise glass fibers and/or carbon fibers, the second fibers comprise glass fibers and/or carbon fibers, and the second direction is within 0 to 90 degrees of the first direction,
wherein the binder constitutes up to about 5 wt. % of the functionalized fabric, and the functionalized fabric having a surface on which at least some of the binder is present having an average gloss value of about 65 G.U. or less.

In an aspect, the present invention provides a fabric stack comprising at least two layers of a functionalized fabric described herein.

In an aspect, the present invention provides a shaped component comprising a fabric stack described herein.

In an aspect, the present invention provides a process for producing a functionalized fabric, the process comprising:
providing a fiber fabric comprising first fibers oriented in a first direction and second fibers oriented in a second direction, the first fibers comprising glass fibers and/or carbon fibers, the second fibers comprising glass fibers and/or carbon fibers, and the second direction being within 0 to 90 degrees of the first direction;
applying binder particles having a glass transition temperature of up to about 75° C. to the fiber fabric; and adhering the binder particles to the fiber fabric to provide the functionalized fabric, wherein the binder is applied to the fiber fabric in an amount such that the binder constitutes up to about 5 wt. % of the functionalized fabric.

In an aspect, the present invention provides a process for producing a functionalized fabric, the process comprising:
providing a fiber fabric comprising first fibers oriented in a first direction and second fibers oriented in a second direction, the first fibers comprising glass fibers and/or carbon fibers, the second fibers comprising glass fibers and/or carbon fibers, and the second direction being within 0 to 90 degrees of the first direction;
applying binder having a glass transition temperature of up to about 75° C. to the fiber fabric to provide the functionalized fabric; and
adhering the binder to the fiber fabric,
wherein the binder is applied to the fiber fabric in an amount such that the binder constitutes up to about 5 wt. % of the functionalized fabric, and
wherein the functionalized fabric has a surface on which at least some of the binder is present having an average gloss value of about 65 G.U. or less.

In an aspect, the present invention provides a process for producing a shaped component, the process comprising:
stacking a plurality of layers of a functionalized fabric described herein;
shaping the stacked plurality of layers of fabric to form a shaped stack;
heating the shaped stack at a temperature up to about 150° C. to provide a shaped component.

In an aspect, the present invention provides a roll of functionalized fabric as described herein.

The present inventors have found that the present invention provides a functionalized fabric which provides improvements in the efficiency of the production of reinforced structure components such as wind turbine blades and related components.

The present inventors have found that adhering low amounts of binder particles to fiber fabrics as described herein (for example, less than 5 wt. % (for example less than 3.5 wt. % or 0.1 to 3.5 wt. %) by total weight of the functionalized fabric and/or from about 2 to about 30 g/m² (for example about 2 to about 20 g/m²) of the functionalized fabric) provides functionalized fabrics with distinct binder particles adhered to a surface of the fiber fabric (for example, adhered binder particles with a maximum axial length of up to about 1 mm) and that the resulting functionalized fabrics have excellent handleability as well as providing improvements in efficiency of the production of reinforced structural components such as wind turbine blades.

The present inventors have found that the functionalized fabrics described herein can be stacked to form fabric stacks, the binder of the functionalized fabrics allowing the layers of fabric of the fabric stacks to be adhered to one another to form consolidated fabric stacks exhibiting excellent adhesion. The present inventors have also found that the functionalized fabrics, fabric stacks and consolidated fabric stacks described herein can be straightforwardly shaped and that once shaped the shaped fabrics or fabrics stacks maintain the shaped form (for example, after removal from a mold).

The present inventors have surprisingly found that fiber fabrics comprising low amounts of binder (e.g. binder particles) as described herein (for example, less than 5 wt. % (for example less than 3.5 wt. % or 0.1 to 3.5 wt. %) by total weight of the functionalized fabric and/or from about 2 to about 30 g/m² (for example about 2 to about 20 g/m²) of the functionalized fabric) having a glass transition temperature of up to about 75° C., and the functionalized fabric having a surface having an average gloss value about 65 G.U. or less (for example, about 25 G.U. to about 65 G.U. or about 25 G.U. to about 65 G.U.) can be stacked and shaped (i.e. pre-shaped) before being incorporated into a reinforced structural component.

The provision of the functionalized fabrics described herein has been found to surprisingly increase the speed at which a reinforced structural component, e.g. a wind turbine blade, can be produced. The functionalized fabrics described herein have also be found to exhibit excellent handleability, in particular the functionalized fabrics can be rolled, cut and stacked without shedding binder. Even more surprisingly, the present inventors have found that the functionalized fabrics described herein can provide improvements in the efficiency of the production of reinforced structural components, e.g. wind turbine blades, without detrimentally effecting the mechanical properties of the fabrics or the final components.

The invention includes the combination of the aspects, embodiments and preferred features described herein except where such a combination is clearly impermissible or expressly avoided.

### BRIEF DESCRIPTION OF THE FIGURES

Embodiments and experiments illustrating the principles of the invention will now be discussed with reference to the accompanying figures in which:

FIG. 1 is a graph showing the particle size distribution of different binder particles that may be applied to a fiber fabric to produce a functionalized fabric as described herein;

FIG. 2 is an image produced by a 3D microscope of a functionalized fabric described herein;

FIG. 3a is a schematic diagram of a cross-section through a fabric stack;

FIG. 3b is a schematic diagram of a cross-section through a fabric stack;

FIG. 4a is an image produced by a 3D microscope of a functionalized fabric described herein;

FIG. 4b is a graph showing the binder particle size distribution on the surface of the functionalized fabric shown in FIG. 4a;

FIG. 5a is an image produced by a 3D microscope of a functionalized fabric described herein; and

FIG. 5b is a graph showing the binder particle size distribution on the surface of the functionalized fabric shown in FIG. 5b.

### DETAILED DESCRIPTION

Aspects and embodiments of the present invention will now be discussed with reference to the accompanying figures. Further aspects and embodiments will be apparent to those skilled in the art.

Described herein is a functionalized fabric comprising a fiber fabric and binder particles, the binder particles adhered to a surface of the fiber fabric and having a glass transition temperature of about 75° C. or less, the binder particles constituting up to about 5 wt. % of the functionalized fabric.

Also described herein is a functionalized fabric comprising a fiber fabric and binder (e.g. binder particles), the binder having a glass transition temperature of about 75° C. or less and constituting up to about 5 wt. % of the functionalized fabric, the functionalized fabric having a surface comprising binder, the surface having an average gloss value about 65 G.U or less.

### Fiber Fabric

The fiber fabric comprises:
first fibers oriented in a first direction; and
second fibers oriented in a second direction, wherein the first fibers comprise glass fibers and/or carbon fibers, the second fibers comprise glass fibers and/or carbon fibers, and the second direction is within 0 to 90 degrees of the first direction.

The first fibers of the fiber fabrics may be referred to as warp fibers. The first fibers may be arranged side by side and substantially parallel to one another. The second fibers of the fiber fabric may be referred to as weft fibers. The second fibers may be arranged side by side and substantially parallel to one another.

In embodiments, the fiber fabric comprises first fibers oriented in a first direction and second fibers oriented in a second direction, wherein the second direction is within 0 to 90 degrees of the first direction, for example, within about 10 degrees to about 90 degrees of the first direction, within about 20 degrees to about 90 degrees of the first direction, within about 30 degrees to about 90 degrees of the first direction, within about 40 degrees to about 90 degrees of the first direction, within about 45 degrees to about 90 degrees of the first direction, within about 60 degrees to about 90 degrees of the first direction, within about 70 to about 90 degrees of the first direction, within about 80 to about 90 degrees of the first direction, within about 85 to about 90 degrees of the first direction, within about 88 to about 90 degrees of the first direction, or within about 90 degrees of the first direction.

In embodiments, the fiber fabric may be a unidirectional fabric or a multiaxial fabric such as a biaxial fabric.

In embodiments, the fiber fabric is a unidirectional fabric. A fiber fabric that is a unidirectional fabric can comprise second fibers oriented in a second direction wherein the second direction is oriented in a direction greater than 0 degrees of the first direction. For example, a unidirectional fabric may comprise first fibers oriented in a first direction and second fibers oriented in a second direction, wherein the second direction is from about 0 to 90 degrees of the first direction, for example, within about 45 degrees to about 90 degrees of the first direction, within about 60 degrees to about 90 degrees of the first direction, within about 70 to about 90 degrees of the first direction, within about 80 to about 90 degrees of the first direction, within about 85 to about 90 degrees of the first direction, within about 88 to about 90 degrees of the first direction, or within about 90 degrees of the first direction. In a unidirectional fabric the first fibers may constitute greater than about 90 wt. % of the fiber fabric, for example greater than about 92 wt. % of the fiber fabric, or at least about 95 wt. % of the fiber fabric. In a unidirectional fabric the second fibers may constitute up to about 10 wt. %, for example up to about 8 wt. %, or up to about 5 wt. % of the fiber fabric. In a unidirectional fabric, the second direction may be substantially perpendicularly to the first direction, the first fibers may constitute greater than 92 wt. % of the fiber fabric, and the second fibers may constitute up to about 8 wt. % of the fiber fabric. In embodiments, the fiber fabric is a unidirectional fabric, the second direction is substantially perpendicularly to the first direction and the weight ratio of first fibers to second fibers is in the range of 15:1 to 25:1.

In embodiments, the fiber fabric is a biaxial fabric. In a biaxial fabric the second direction may be within about 20 degrees to about 90 degrees of the first direction, for example the second direction may be within about 30 degrees to about 90 degrees of the first direction, the second direction may be within about 40 degrees to about 90 degrees of the first direction, the second direction may be within about 45 degrees to about 90 degrees of the first direction, the second direction may be within about 60 degrees to about 90 degrees of the first direction, within about 70 to about 90 degrees of the first direction, within about 80 to about 90 degrees of the first direction, within about 85 to about 90 degrees of the first direction, within about 88 to about 90 degrees of the first direction, or within about 90 degrees of the first direction. In embodiments, the fiber fabric is a biaxial fabric wherein the second direction is around 25 to 75 degrees of the first direction, for example about 45 degrees of the first direction. In embodiments, the fiber fabric is a biaxial fabric wherein the second direction is at least 45 degrees of the first direction. In embodiments, the fiber fabric is a biaxial fabric and the second direction is substantially perpendicular to the first direction. In embodiments where the fiber fabric is a biaxial fabric the second fibers constitute greater than 5 wt. % of the fiber fabric. In embodiments where the fiber fabric is a biaxial fabric the second fibers may constitute at least about 10 wt. % of the fiber fabric, for example at least about 15 wt. %, at least about 20 wt. %, or at least about 25 wt. % of the fiber fabric.

In embodiments, at least the first fibers or the second fibers comprise, consist essentially of, or consist of glass fibers.

In embodiments, both the first fibers and the second fibers comprise, consist essentially of, or consist of glass fibers.

In embodiments, glass fibers constitute at least about 50 wt. % of the fiber fabrics described herein, for example at least about 60 wt. % of the fiber fabric, at least about 70 wt. % of the fiber fabric, at least about 80 wt. % of the fiber fabric, at least about 90 wt. % of the fiber fabric, or at least about 95 wt. % of the fiber fabric.

The term “glass fibers” is used herein to refer to a plurality of continuous glass filaments (the term “continuous” as used here is used to refer to a fiber/filament that has a length many times longer than its diameter, for example at least about 5000 times longer than its diameter, e.g. at least about 10 000 times longer than its diameter). The glass fibers used in the fabrics described herein may be provided as glass fiber strands (or tows). The glass fibers may be formed by a continuous manufacturing process in which molten glass passes through the holes of a “bushing,” the streams of molten glass thereby formed are solidified into filaments/fibers. The glass fibers described herein (e.g. the glass fibers of the first and/or second fibers) may include a sizing on their surface, e.g. a sizing applied on the glass fibers during formation of the fibers. The sizing can include components such as a film former, lubricant, coupling agent (to promote compatibility between the glass fibers and the resin used to form a composite article comprising the hybrid fabric described herein), etc. that facilitate formation of the glass fibers and/or use thereof in a matrix resin. In some embodiments, the glass fibers of first and/or second fibers include a polyester compatible sizing or an epoxy compatible sizing.

The term “glass fiber strand” or “glass fiber tow” as used herein, refers to a bundle of continuous glass filaments. In embodiments the glass fiber strands or tows are bundles of untwisted glass filaments.

In embodiments, glass fiber strands or glass fiber tows are provided from glass fiber direct rovings. Glass fiber direct rovings are made up of a bundle of continuous untwisted (i.e. substantially parallel, or parallel) glass filaments bonded (as the glass filaments are formed) into a single strand and wound onto a bobbin.

Any suitable glass reinforcing fibers may be employed as the first or second fibers, for example, fibers made from E glass, E-CR glass (such as Advantex™ glass fibers available from Owens Corning), C glass, H glass, S glass, and AR glass types can be used.

In embodiments, the glass fibers referred to herein (for example, the first fibers which may be glass fibers and/or the second fibers that may be glass fibers) have a linear mass density in the range of about 50 Tex to about 5000 Tex, for example about 200 Tex to about 4800 Tex, about 300 Tex to about 2500 Tex, about 300 Tex to about 2400 Tex, or about 600 Tex to about 1200 Tex.

The term “carbon fibers” used herein to refer to a plurality of continuous carbon filaments (the term “continuous” as used here is used to refer to a fiber/filament that has a length many times longer than its diameter, for example at least about 5000 times longer than its diameter, e.g. at least about 10 000 times longer than its diameter). The carbon fibers used in the fabrics described herein may be provided as carbon fiber tows (or strands) which are bundles of continuous carbon filaments. The carbon fibers described herein (e.g. the carbon fibers of the first and/or second fibers) may include a sizing on their surface, e.g. a sizing applied on the carbon fibers during formation of the fibers. The sizing can include components such as a film former, lubricant, coupling agent (to promote compatibility between the carbon fibers and the resin used to form a composite article comprising the hybrid fabric described herein), etc. that facilitate formation of the carbon fibers and/or use thereof in a matrix resin. In some embodiments, the carbon fibers include a polyester compatible sizing or an epoxy compatible sizing.

In embodiments, the carbon fibers have a linear mass density in the range of about 100 Tex to about 5000 Tex, for example about 200 Tex to about 5000 Tex, about 400 Tex to about 5000 Tex, about 600 Tex to about 5000 Tex, about 800 Tex to about 5000 Tex, about 100 Tex to about 4800 Tex, about 200 Tex to about 4800 Tex, 400 Tex to about 4800 Tex, about 600 Tex to about 4800 Tex, about 800 Tex to about 4800 Tex, about 100 Tex to about 2400 Tex, about 200 Tex to about 2400 Tex, about 400 Tex to about 2400 Tex, about 100 Tex to about 2000 Tex, about 200 Tex to about 2000 Tex, about 400 Tex to about 2000 Tex, about 600 Tex to about 2000 Tex, about 800 Tex to about 2000 Tex, or about 1200 Tex.

In embodiments, carbon fibers (where present) are provided by carbon fiber tows (strands of carbon fibers). In embodiments, the carbon fibers tows have a size in the range of 6K to 50K, for example 6K to 24K, or 6K to 12K. For example, the first fibers may be fed from one or more carbon fiber tows having a size in the range of 6K to 50K, for example 6K to 24K, or 6K to 12K. The nomenclature #K means that the carbon tow is made up of #x 1,000 individual carbon filaments, i.e. a carbon fiber tow having a size of 6K is made up of approximately 6000 carbon fiber filaments/fibers.

In embodiments, the fiber fabric is a non-crimp fabric, the first and second fibers are maintained in their respective orientations with a stitching yarn (as opposed to the first and second fibers being woven together, i.e. a non-crimp fabric is a non-woven fabric). Any suitable stitching yarn may be employed. In embodiments, the stitching yarn is a polyester yarn. In embodiments, the stitching yarn has a linear mass density in the range of about 50 dTex to about 300 dTex. In embodiments, the stitching yarn forms a stitching pattern through the fabric, the stitching pattern may be selected from a tricot stitching pattern, a symmetric double tricot stitching pattern, an asymmetric double tricot stitching pattern, a symmetric stitching pattern, and an asymmetric stitching pattern. In embodiments, the stitching yarn forms a stitching pattern through the fabric, the stitching pattern being a tricot stitching pattern. In embodiments, the stitching yarn defines a stitching length, the stitching length being in the range of about 2 mm to about 7 mm, for example about 3 mm.

In embodiments, the fiber fabric is a woven fabric, for example a plain woven fabric, warp knitted fabric or a twill woven fabric.

In embodiments, the fiber fabric consists essentially of or consists of glass fibers and/or carbon fibers. In embodiments, the fiber fabric consists essentially of or consists of glass fibers and carbon fibers. In embodiments, the fiber fabric consists essentially of or consists of glass fibers.

In embodiments, the fiber fabric comprises glass fibers. In embodiments the fiber fabric comprises additional fibers in addition to glass fibers. In embodiments, the fiber fabric includes additional fibers in addition to glass fibers and/or carbon fibers. Examples of other fibers which may be included in the fiber fabric include polymer fibers such as PET.

In embodiments, the fiber fabric has an areal weight in the range of about 200 g/m² to about 2500 g/m², for example about 300 g/m² to about 2000 g/m², for example about 500 g/m² to about 1500 g/m², for example about 500 g/m² to about 1300 g/m², for example about 1300 g/m² to about 2500 g/m². The areal weight of the fiber fabric may be determined according to ISO 3374.

In embodiments, the fiber fabric comprises:
first fibers oriented in a first direction; and
second fibers oriented in a second direction,
   wherein the first fibers comprise glass fibers, the second fibers comprise glass fibers, the second direction is within 45 to 90 degrees of the first direction, and the first and second fibers being maintained in their respective orientations with a stitching yarn.

In embodiments, the fiber fabric comprises:
first fibers oriented in a first direction; and
second fibers oriented in a second direction,
   wherein the first fibers comprise glass fibers, the second fibers comprise glass fibers, the second direction is within 45 to 90 degrees of the first direction, the first and second fibers being maintained in their respective orientations with a stitching yarn, and the glass fibers of first and/or second fibers including a polyester compatible sizing or an epoxy compatible sizing.

In embodiments, the fiber fabric comprises:
first fibers oriented in a first direction; and
second fibers oriented in a second direction,
   wherein the first fibers comprise glass fibers, the second fibers comprise glass fibers, the second direction is within 45 to 90 degrees of the first direction, the first and second fibers are maintained in their respective orientations with a stitching yarn, the glass fibers of first and/or second fibers including a polyester compatible sizing or an epoxy compatible sizing, and the fiber fabric having an areal weight in the range of about 500 g/m² to about 2500 g/m².

### Binder

The functionalized fabric comprises a binder (e.g. binder particles). The functionalized fabric may be described herein as comprising binder particles. The functionalized fabric may be described herein as comprising a fiber fabric with binder particles adhered to a surface of the fiber fabric.

In embodiments, the binder (e.g. binder particles) comprises, consists essentially of, or consists of a resin binder. In embodiments, the binder (e.g. binder particles) comprises or is composed of a thermoplastic resin. In embodiments, the binder (e.g. binder particles) comprises or is composed of a thermoplastic resin selected from an epoxy resin, an acrylate resin, or a polyester resin. In embodiments, the binder (e.g. binder particles) comprises or is composed of a thermoplastic resin selected from an epoxy resin or a polyester resin. In embodiments, the binder comprises or consists of a resin comprising epoxy, acrylate, or ester functional groups, for example a resin comprising epoxy, or ester functional groups. In embodiments, the binder (e.g. binder particles) comprises or consists of a biobased resin, for example a biobased resin comprising epoxy, acrylate, or ester functional groups, for example a biobased resin comprising epoxy, or ester functional groups.

In embodiments, the binder (e.g. binder particles) has a glass transition temperature of up to about 75° C., for example up to about 70° C., up to about 65° C., up to about 60° C., or up to about 55° C. In embodiments, the binder has a glass transition temperature of at least about 30° C., for example at least about 35° C., or at least about 40° C. In embodiments, the binder has a glass transition temperature in the range of about 30° C. to about 75° C., for example about 40° C. to about 70° C. The glass transition temperature of the binder may be determined using differential scanning calorimetry (DSC) according to EN ISO 11357-2 (determination of glass transition temperature). The glass transition temperature of the binder may be determined using differential scanning calorimetry (DSC) according to EN ISO 11357-2 (determination of glass transition temperature) wherein the glass transition temperature is determined as the value provided on the second heating cycle. The glass transition temperature of the binder may be determined according to the EN ISO 11357-2 test method by heating the binder under an air flow of 80 mL/min at a heating rate of 10K/min, heating from −60° C. to 120° C. In embodiments, the glass transition temperature of the binder may be determined according to the EN ISO 11357-2 test method by heating the binder under an air flow of 80 ml/min at a heating rate of 10K/min, heating from −60° C. to 120° C. and then holding for 5 mins at 120° C. before cooling from 120° C. to −60° C. at a cooling rate of 10K/min and then holding for 5 mins at −60° C. before heating from −60° C. to 120° C. again at a heating rate of 10K/min and the glass transition temperature is determined as the value provided on the second heating cycle.

In embodiments, the binder (e.g. binder particles) has a melting point such that the binder is completely molten when exposed to a temperature of up to about 120° C. for at least suitable time period, for example when exposed to a temperature of up to about 110° C. for at least suitable time period, when exposed to a temperature of up to about 100° C. for at least suitable time period, or when exposed to a temperature of up to about 90° C. for at least suitable time period. In embodiments, the binder has a melting point such that the binder is completely molten when exposed to a temperature in the range of about 60° C. to about 120° C., for example about 80° C. to about 120° C. for at least suitable time period. The suitable time period may be up to 1 hour, for example up to 30 mins. The suitable time period may be at least about 1 min, for example, at least about 5 mins or at least about 10 mins.

In embodiments, the binder (e.g. binder particles) has a softening temperature in the range of about 50° C. to about 100° C., for example about 60° C. to about 100° C. In embodiments, the softening temperature may be determined using an oscillatory rheometer at 0.1% deformation in plan-plan geometry, a frequency of 1 Hz with a binder sample having a thickness of 400 μm and diameter of 25 mm, employing a heating-cooling-heating cycle which heats from 30° C.-130° C. at a rate of 3° C./min, cooling from 130° C.-30° C. and heating from 30° C.-130° C. at a rate of 3° C./min. The softening temperature is taken during the first heating.

In embodiments, the binder is applied to the fiber fabric as binder particles. The binder particles before being applied to the fiber fabric may have a volume average particle size of up to about 1 mm, for example up to about 800 μm, up to about 600 μm, up to about 500 μm, up to about 400 μm, up to about 300 μm, or up to about 200 μm. In embodiments, the binder particles before being applied to the fiber fabric have a volume average particle size of greater than about 10 μm, for example greater than about 20 μm, greater than about 30 μm, greater than about 40 μm, or greater than about 50 μm. In embodiments, the binder particles before being applied to the fiber fabric have a volume average particle size in the range of about 10 μm to about 1 mm, for example about 20 μm to about 600 μm, about 30 μm to about 500 μm, about 40 μm to about 400 μm, or about 50 μm to about 300 μm. The volume average particle size of the binder particles before being applied to the fiber fabric may be determined using a dynamic light scattering technique on a dispersion of the binder particles. A Particle size analyzer such as a LS13320 Particle Size Analyzer from Beckman™ may be employed to determine the volume average particle size by laser diffraction following the ISO 13320 2009 norm (i.e. using a dynamic light scattering technique on a dispersion of the binder particles before being applied to the fiber fabric). The samples may be analyzed twice, as received, after dispersion in air and the sample quantity is typically around 20 g per test.

In embodiments, the binder of the functionalized fabric can be described as binder particles.

The binder particles applied to the fiber fabric may be adhered to a surface of the fiber fabric such that the functionalized fabric comprises binder particles adhered to a surface. The binder particles applied to the surface of a fiber fabric may be adhered to the fiber fabric to form the functionalized fabric. Due to the low amount of binder particles applied to the fiber fabric as described herein, the functionalized fabric comprises a fiber fabric with binder particles adhered to the fiber fabric, the binder particles forming distinct binder particles on a surface of the fiber fabric (for example, as opposed to the binder coagulating to form large patches or a layer over the surface of the fiber fabric). The terms “distinct binder particles” and “discrete binder particles” are used herein to refer to binder particles adhered to the surface of the fiber fabric being spaced apart from one another, that is around each binder particle there is an area of the surface of the fiber fabric that is free from binder particles. In embodiments, the binder particles adhered to a surface of the fiber fabric have a longest axial length of less than about 2 mm, for example less than about 1 mm.

In embodiments, the binder particles adhered to a surface of the functionalized fabric have a size distribution such that at least about 90 wt. % of the binder particles adhered to a surface of the fiber fabric have a longest axial length of less than about 2 mm, for example, less than about 1 mm, less than about 800 μm, less than about 700 μm, less than about 600 μm, or less than about 500 μm. In embodiments, the binder particles adhered to a surface of the functionalized fabric have a size distribution such that the binder particles adhered to a surface of the fiber fabric have a longest axial length of at least about 1 μm, at least about 10 μm, or at least about 20 μm. In embodiments, the binder particles adhered to a surface of the functionalized fabric have a size distribution such that at least about 90 wt. % of the binder particles adhered to a surface of the fiber fabric have a longest axial length of at least about 1 μm, at least about 10 μm, or at least about 20 μm.

In embodiments, the binder particles adhered to a surface of the functionalized fabric have a size distribution such that the binder particles adhered to a surface of the fiber fabric have a longest axial length in the range of about 1 μm to about 1 mm, for example in the range of about 1 μm to about 800 μm.

In embodiments, the binder particles adhered to a surface of the functionalized fabric have a size distribution such that at least about 90 wt. % of the binder particles adhered to a surface of the fiber fabric have a longest axial length in the range of about 1 μm to about 1 mm, for example in the range of about 1 μm to about 800 μm, about 10 μm to about 600 μm, or about 10 μm to about 500 μm.

In embodiments, the binder particles adhered to a surface of the functionalized fabric have a size distribution such that at least 90% of the binder particles (by number of particles) adhered to a surface of the fiber fabric have a longest axial length of less than about 2 mm, for example, less than about 1 mm, less than about 800 μm, less than about 700 μm, less than about 600 μm, or less than about 500 μm. In embodiments, the binder particles adhered to a surface of the functionalized fabric have a size distribution such that at least 90% of the binder particles (by number of particles) adhered to a surface of the fiber fabric have a longest axial length of at least about 1 μm, at least about 10 μm, or at least about 20 μm. In embodiments, the binder particles adhered to a surface of the functionalized fabric have a size distribution such that at least 90% of the binder particles (by number of particles) adhered to a surface of the fiber fabric have a longest axial length in the range of about 1 μm to about 1 mm, for example in the range of about 1 μm to about 800 μm, about 10 μm to about 600 μm, or about 10 μm to about 500 μm.

The longest axial length of a binder particle of the functionalized fabric can be determined by measuring the largest dimension across the binder particle adhered to the fiber fabric. An optical microscope such as a Keyence™ optical microscope may be used to determine the longest axial length of a binder particle adhered to the fiber fabric. The binder particle size distribution can be determined using an optical microscope (such as a Keyence™ optical microscope, e.g., Keyence™ VHX-500) and associated image analysis software (for example, ImageJ software). The binder particle size distribution can be determined using an optical microscope and associated image analysis software (for example, as described herein) to calculate the binder particle size distribution over a given area of functionalized fabric (for example, an area of functionalized fabric in the range of about 5 mm² to about 50 mm², for example an area of functionalized fabric in the range of about 5 mm² to about 20 mm², an area of functionalized fabric in the range of about 5 mm² to about 10 mm²). In Examples, the binder particle size distribution can be determined using an optical microscope and associated image analysis software (for example, as described herein) to calculate the binder particle size distribution over a 5 mm² or 10 mm² area of functionalized fabric.

In embodiments, the binder of the functionalized fabric can be described as binder particles having a volume average particle size (i.e. after application and adherence/fixing (e.g. by melting) to the fiber fabric) may be determined using a numerical aperture microscope (for example Keyence™ VHX-500) and associated image analysis software (for example, the size of each particle may be determined as the largest dimension across the particle, i.e. the longest axial length of the particle adhered to the surface of the fabric). In embodiments, the volume average particle size of the binder particles after application and adherence/fixing to the fiber fabric is in the range of about 10 μm to about 1 mm, for example about 20 μm to about 600 μm, about 30 μm to about 500 μm.

In embodiments, the binder of the functionalized fabric can be described as binder particles and the binder particles before being applied to the fiber fabric have a D90 particle size of less than (i.e. 90% by volume of the particles have a particle size less than) about 1 mm, for example less than about 800 μm, less than about 600 μm, less than about 500 μm, less than about 400 μm, less than about 300 μm, or less than about 200 μm. The D90 particle size (by volume) may be determined by sieve analysis according to ISO 8130-1.

In embodiments, the binder (e.g. binder particles) has a shear modulus, G, at 30° C. in the range of about 5 to about 50 Mpa, for example about 5 to about 40 Mpa, or about 7 to about 30 Mpa. The shear modulus, G, at 30° C. of the binder may be determined using an oscillatory rheometer at 0.1% deformation in plan-plan geometry, a frequency of 1 Hz with a binder sample having a thickness of 400 μm and diameter of 25 mm, employing a heating-cooling-heating cycle which heats from 30° C.-130° C. at a rate of 3° C./min, cooling from 130° C.-30° C. and heating from 30° C.-130° C. at a rate of 3° C./min.

In embodiments, the binder (e.g. binder particles) has a dynamic viscosity, n, at 130° C. in the range of about 1 to about 400 Pa·s, for example about 10 to about 400 Pa·s. The dynamic viscosity, n, at 130° C. of the binder may be determined using an oscillatory rheometer at 0.1% deformation in plan-plan geometry, a frequency of 1 Hz with a binder sample having a thickness of 400 μm and diameter of 25 mm, employing a heating-cooling-heating cycle which heats from 30° C.-130° C. at a rate of 3° C./min, cooling from 130° C.-30° C. and heating from 30° C.-130° C. at a rate of 3° C./min.

In embodiments, the binder (e.g., binder particles) comprises or is composed of a resin comprising epoxy functional groups, for example the binder may be an epoxy resin. In embodiments, the binder comprises or is composed of an epoxy resin having a molecular weight, Mw, in the range of about 2000 to about 6000, for example about 3000 to about 6000, about 4000 to about 6000, or about 4500 to about 5500. In embodiments, the binder comprises or is composed of an epoxy resin having a molecular weight, Mw, in the range of about 2000 to about 6000 and a polydispersity in the range of 1 to 5, for example 2 to 4, 2 to 3 or 2.5 to 3 (where polydispersity is calculated as Mw/Mn). In embodiments, the binder comprises or is composed of an epoxy resin and the epoxy resin is an epoxylated BPA or an epoxy novalac. In embodiments, the binder comprises or is composed of an epoxy resin and the epoxy resin is an epoxylated BPA.

In embodiments, the binder (e.g., binder particles) comprises or is composed of a resin comprising ester functional groups, for example the binder may be a polyester resin. In embodiments, the binder comprises or is composed of a polyester resin having a molecular weight, MW, in the range of about 1000 to about 300000. In embodiments, the binder comprises or is composed of an unsaturated polyester resin, for example an aromatic unsaturated polyester resin or an aliphatic unsaturated polyester resin. Examples of suitable polyester-based resins include BPA polyesters such as BPA fumarate polyesters, for example alkoxylated (e.g. ethoxylated or propoxylated) BPA fumarate polyesters.

At least some of the binder (e.g., binder particles) of the functionalized fabric is present on a surface of the functionalized fabric. For example, at least some of the binder of the functionalized fabric is disposed on a surface of the fiber fabric or between fibers on a surface of the fiber fabric.

In embodiments, the majority of the binder (e.g., binder particles) of the functionalized fabric is disposed on a surface of the fiber fabric. For example, in embodiments, at least 50 wt. % of the binder of the functionalized fabric is disposed on one surface of the fiber fabric, for example at least about 60 wt. %, at least about 75 wt. %, at least about 85 wt. % or at least about 90 wt. %.

In embodiments, the binder of the functionalized fabric may be applied to the fiber fabric in the form of binder particles (which may also be described as powder binder particles), a dispersion comprising the binder or a solution comprising the binder.

In embodiments, the binder of the functionalized fabric may penetrate the fiber fabric. In embodiments, the functionalized fabric may comprise binder, for example binder particles, within the fiber fabric.

### Functionalized Fabric

The functionalized fabric of the invention comprises a fiber fabric as described herein and binder (e.g. binder particles) as described herein.

The binder (e.g. binder particles) constitutes up to about 5 wt. % of the functionalized fabric. In embodiments, the binder constitutes up to about 5.0 wt. % of the functionalized fabric, for example up to about 4.5 wt. %, up to about 4.0 wt. %, or up to about 3.5 wt. % of the functionalized fabric. In embodiments, the binder constitutes at least about 0.1 wt. % of the functionalized fabric, for example at least about 0.2 wt. %, or at least about 0.3 wt. % of the functionalized fabric. In embodiments, the binder constitutes from about 0.1 wt. % to about 5.0 wt. % of the functionalized fabric, for example from about 0.1 wt. % to about 4.0 wt. %, or from about 0.2 wt. % to about 3.5 wt. % of the functionalized fabric.

In embodiments, glass fibers constitute at least about 50 wt. % of the functionalized fabric, for example at least about 60 wt. % of the functionalized fabric, at least about 70 wt. % of the functionalized fabric, at least about 80 wt. % of the functionalized fabric, or at least about 90 wt. % of the functionalized fabric.

In embodiments, the functionalized fabric comprises up to about 30 g/m² of the binder (e.g. binder particles), for example, up to about 25 g/m², up to about 20 g/m², up to about 18 g/m², up to about 16 g/m², up to about 15 g/m², or up to about 13 g/m² of the binder. In embodiments, the functionalized fabric comprises at least about 2 g/m² of the binder, for example at least about 4 g/m², at least about 5 g/m², at least about 7 g/m², at least about 8 g/m², or at least about 10 g/m² of the binder. In embodiments, the functionalized fabric comprises from about 2 g/m² to about 30 g/m² of the binder, for example about 4 g/m² to about 25 g/m², about 4 g/m² to about 15 g/m², about 7 g/m² to about 13 g/m², or about 10 g/m² to about 13 g/m² of the binder.

In embodiments, the functionalized fabric comprises binder (e.g. binder particles) disposed on a surface of a fiber fabric. The fiber fabric may be described as a generally two-dimensional fabric having a top surface and a bottom surface. In embodiments, the functionalized fabric may comprise a fiber fabric having one surface on which binder particles are disposed and another surface which is substantially free of binder particles (for example a surface comprising less than about 0.1 g/m² binder particles).

In embodiments, the functionalized fabric may comprise binder particles within the fiber fabric.

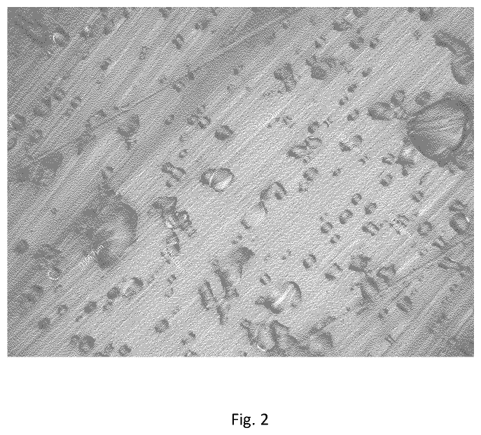

The functionalized fabric comprises a fiber fabric and binder (e.g. binder particles), the binder being adhered to the fiber fabric. In embodiments, the binder is adhered to the fiber fabric, for example a surface of the fiber fabric. In embodiments, the binder may be adhered to the fiber fabric by a suitable treatment such as heating, curing, or exposure to UV radiation for example. In embodiments the binder is adhered to the fiber fabric, for example a surface of the fiber fabric, by being heated such that the binder melts or at least partially melts, for example at least partially melt on a surface of the fiber fabric. For example, the functionalized fabric may comprise solid binder, for example solid binder particles, adhered to the fiber fabric, wherein the binder, for example binder particles, applied to the fiber fabric have previously been softened or at least partially melted. The inventors have found that due to the low amount of binder (e.g. binder particles) applied to the fiber fabric, even after melting the binder, discrete areas of binder (may be referred to as binder particles or distinct binder particles) are provided in the functionalized fabric, for example on a surface of the functionalized fabric. FIG. 2 is a 3D microscope image of an example of a functionalized fabric as described herein, it can be seen that binder particles applied to the surface of a fiber fabric which were then melted and solidified have not coagulated to form a layer over the fabric surface but instead can be seen as distinct binder particles. The terms “distinct binder particles” or “discrete binder particles” may be used herein to describe binder particles adhered to fiber fabric having a size distribution as described herein. As described above, the terms “distinct binder particles” and “discrete binder particles” are used herein to refer to binder particles adhered to the surface of the fiber fabric being spaced apart from one another, that is around each binder particle there is an area of the surface of the fiber fabric that is free from binder particles.

The present inventors have found that the functionalized fabrics described herein which comprise a fiber fabric with about 5 wt. % or less binder (e.g., binder particles) adhered to the fiber fabric (by total weight of the functionalized fabric) can be described as comprising fiber fabrics having a surface to which binder (e.g., binder particles) is permanently adhered. The term “permanently adhered” is used herein to refer to binder (e.g., binder particles) that cannot be removed from the fiber fabrics by abrasion (for example following the abrasion tests described in the examples section below). The binder (e.g., binder particles) may be permanently adhered to a surface of the fiber fabric by softening or at least partially melting the binder on the surface of the fiber fabric as described herein. For example, binder is considered to be permanently adhered to a surface of a fiber fabric, if following a scrub test carried out according to ISO 11998-2006 (using Elcometer 1720 Abrasion Tester) without liquid and using a microfiber fabric or a Scotch-Brite™ 7446 type pad as the abrasive pad (weight of abrasive pad with holder being 455 g, scrubbed surface being 300 mm long, performing 200 runs (back and forth)) no impact on binder adhesion is observed and no weight loss occurs.

In embodiments, the functionalized fabric comprises binder particles adhered to a surface of the fiber fabric. For example, the functionalized fabric may comprise solid binder particles adhered to the fiber fabric, wherein the binder particles have previously been softened or at least partially melted on the surface of the fiber fabric.

In embodiments, the functionalized fabric described herein may be impregnated with a resin and the resin cured to form a composite article.

In embodiments, the functionalized fabric comprises:
a fiber fabric; and
binder particles having a glass transition temperature of up to about 75° C.,
   wherein the fiber fabric comprises:
first fibers oriented in a first direction; and
second fibers oriented in a second direction, the first fibers comprising glass fibers and/or carbon fibers, the second fibers comprising glass fibers and/or carbon fibers, and the second direction being within 0 to 90 degrees of the first direction,
   wherein the binder particles constitute from about 0.1 wt. % to about 3.5 wt. % of the functionalized fabric, the functionalized fabric comprising from about 2 to about 30 g/m² of the binder particles, the binder particles being adhered to a surface of the fiber fabric,
   wherein the binder particles adhered to a surface of the functionalized fabric have a size distribution such that at least 90% of the binder particles, by total number of particles, adhered to a surface of the fiber fabric have a longest axial length in the range of about 1 μm to about 1 mm.

In embodiments, the functionalized fabric comprises:
a fiber fabric; and
binder particles having a glass transition temperature of up to about 75° C.,
   wherein the fiber fabric comprises:
first fibers oriented in a first direction; and
second fibers oriented in a second direction, the first fibers comprising glass fibers and/or carbon fibers, the second fibers comprising glass fibers and/or carbon fibers, and the second direction being within 0 to 90 degrees of the first direction,
   wherein the binder particles constitute from about 0.1 wt. % to about 3.5 wt. % of the functionalized fabric, the functionalized fabric comprising from about 2 to about 20 g/m² of the binder particles, the binder particles being adhered to a surface of the fiber fabric,
   wherein the binder particles adhered to a surface of the functionalized fabric have a size distribution such that at least 90% of the binder particles, by total number of particles, adhered to a surface of the fiber fabric have a longest axial length in the range of about 1 μm to about 1 mm.

In embodiments, the functionalized fabric comprises:
a fiber fabric; and
   binder particles having a glass transition temperature in the range of about 40° C. to about 70° C.,
      wherein the fiber fabric comprises:
first fibers oriented in a first direction; and
second fibers oriented in a second direction, the first fibers comprising glass fibers and/or carbon fibers, the second fibers comprising glass fibers and/or carbon fibers, and the second direction being within 0 to 90 degrees of the first direction,
   wherein the binder particles constitute from about 0.1 wt. % to about 3.5 wt. % of the functionalized fabric, the functionalized fabric comprising from about 2 to about 20 g/m² of the binder particles, the binder particles being adhered to a surface of the fiber fabric,
   wherein the binder particles adhered to a surface of the functionalized fabric have a size distribution such that at least 90% of the binder particles, by total number of particles, adhered to a surface of the fiber fabric have a longest axial length in the range of about 10 μm to about 1 mm.

In embodiments, the functionalized fabric comprises:
a fiber fabric; and
   binder particles having a glass transition temperature in the range of about 40° C. to about 70° C.,
      wherein the fiber fabric comprises:
first fibers oriented in a first direction; and
second fibers oriented in a second direction, the first fibers comprising glass fibers and/or carbon fibers, the second fibers comprising glass fibers and/or carbon fibers, and the second direction being within 0 to 90 degrees of the first direction,
   wherein the binder particles constitute from about 0.1 wt. % to about 3.5 wt. % of the functionalized fabric, the functionalized fabric comprising from about 2 to about 20 g/m² of the binder particles, the binder particles being adhered to a surface of the fiber fabric,
   wherein the binder particles adhered to a surface of the functionalized fabric have a size distribution such that at least 90% of the binder particles, by total number of particles, adhered to a surface of the fiber fabric have a longest axial length in the range of about 10 μm to about 800 μm.

In embodiments, the functionalized fabric comprises:
a fiber fabric; and
   binder particles having a glass transition temperature in the range of about 40° C. to about 70° C.,
      wherein the fiber fabric comprises:
first fibers oriented in a first direction; and
second fibers oriented in a second direction, the first fibers comprising glass fibers and/or carbon fibers, the second fibers comprising glass fibers and/or carbon fibers, and the second direction being within 0 to 90 degrees of the first direction,
   wherein the binder particles constitute from about 0.1 wt. % to about 3.5 wt. % of the functionalized fabric, the functionalized fabric comprising from about 2 to about 20 g/m² of the binder particles, the binder particles being adhered to a surface of the fiber fabric,
   wherein the binder particles adhered to a surface of the functionalized fabric have a size distribution such that at least 90% of the binder particles, by total number of particles, adhered to a surface of the fiber fabric have a longest axial length in the range of about 10 μm to about 600 μm.

In embodiments, the functionalized fabric comprises:
a fiber fabric; and
   binder particles having a glass transition temperature in the range of about 40° C. to about 70° C.,
      wherein the fiber fabric comprises:
first fibers oriented in a first direction; and
second fibers oriented in a second direction, the first fibers comprising glass fibers and/or carbon fibers, the second fibers comprising glass fibers and/or carbon fibers, and the second direction being within 0 to 90 degrees of the first direction,
   wherein the binder particles constitute from about 0.1 wt. % to about 3.5 wt. % of the functionalized fabric, the functionalized fabric comprising from about 2 to about 20 g/m² of the binder particles, the binder particles being adhered to a surface of the fiber fabric,
   wherein the binder particles adhered to a surface of the functionalized fabric have a size distribution such that at least 90% of the binder particles, by total number of particles, adhered to a surface of the fiber fabric have a longest axial length in the range of about 20 μm to about 500 μm.

In embodiments, at least about 80 wt. % of the binder (e.g., binder particles) is disposed on one surface of the fiber fabric of the functionalized fabric, for example at least about 85 wt. %, at least about 90 wt. %, or at least about 95 wt. % of the binder (e.g., binder particles) are disposed on one surface of the fiber fabric of the functionalized fabric. For example, the functionalized fabric may comprise a fiber fabric having a first surface on which at least about 80 wt. % (e.g., at least about 90 wt. % or at least about 95 wt. %) of the binder (e.g., binder particles) is disposed and a second surface which is substantially free of the binder (for example less than 5 wt. % of the binder (e.g., binder particles) being disposed on the second surface of the fiber fabric, for example less than 3 wt. %, less than 2 wt. %, less than 1 wt. %, or less than 0.5 wt. % of the binder (e.g., binder particles) being disposed on the second surface of the fiber fabric.

In embodiments, the functionalized fabric has a surface on which at least some binder (e.g. binder particles) is present, the surface having an average gloss value of about 65 G.U. or less, for example about 60 G.U. or less. In embodiments, the functionalized fabric has a surface on which at least some binder is present, the surface having an average gloss value in the range of about 20 G.U. to about 65 G.U, for example 25 G.U. to about 65 G.U., or about 25 G.U. to about 60 G.U.

In embodiments, the functionalized fabric comprising the binder (e.g. binder particles) has a surface having an average gloss value at least about 10 G.U. lower than the fiber fabric before application of the binder, for example at least about 15 G.U. lower, at least about 20 G.U. lower, or at least about 25 G.U. lower than the fiber fabric before application of the binder. When the average gloss value of a surface of the functionalized fabric is compared to the average gloss values of a surface of the fiber fabric, the same surface of the fiber fabric either alone or as part of the functionalized fabric comprising the binder should be considered.

In embodiments, the functionalized fabric comprises a unidirectional fiber fabric and binder, the functionalized fabric having a surface on which at least some of the binder (e.g. binder particles) is present having an average gloss value of about 65 G.U. or less, for example about 60 G.U. or less, about 50 G.U, or less. In embodiments, the functionalized fabric comprises a unidirectional fiber fabric and binder, the functionalized fabric having a surface on which at least some of the binder is present having an average gloss value in the range of about 25 to about 65 G.U., for example about 25 G.U. to about 60 G.U. or less, or about 25 G.U. to about 50 G.U.

In embodiments, the functionalized fabric comprises a fiber fabric having an areal weight of greater than 1200 g/m² (for example an areal weight in the range of about 1300 g/m² to about 2500 g/m²) and binder, the functionalized fabric having a surface on which at least some of the binder (e.g. binder particles) is present having an average gloss value in the range of about 25 G.U. to about 60 G.U.

In embodiments, the functionalized fabric comprises a biaxial fiber fabric and binder, the functionalized fabric having a surface on which at least some of the binder (e.g. binder particles) is present having an average gloss value in the range of about 25 G.U. to about 65 G.U.

In embodiments, the functionalized fabric comprises a biaxial fiber fabric having an areal weight of greater than 1200 g/m² (for example an areal weight in the range of about 1300 g/m² to about 2500 g/m²) and binder, and the functionalized fabric having a surface on which at least some of the binder (e.g. binder particles) is present having an average gloss value in the range of about 25 G.U. to about 60 G.U.

In embodiments, the functionalized fabric comprises a biaxial fiber fabric having an areal weight of less than about 1300 g/m² (for example an areal weight in the range of about 500 g/m² to about 1300 g/m²) and binder, and the functionalized fabric having a surface on which at least some of the binder (e.g. binder particles) is present having an average gloss value in the range of about 25 G.U. to about 65 G.U.

In embodiments, the functionalized fabric comprises a fiber fabric having an areal weight of less than about 1300 g/m² (for example an areal weight in the range of about 500 g/m² to about 1300 g/m²) and binder, the functionalized fabric having a surface on which at least some of the binder (e.g. binder particles) is present having an average gloss value in the range of about 25 G.U. to about 65 G.U.

The average gloss value of a fabric may be determined for a surface of a fabric, for example a surface comprising at least some of the binder (e.g. binder particles) of the functionalized fabric. The gloss value may be determined using a spectrophotometer (for example a Spectrophotometer X-Rite Ci7600), for example using a spectrophotometer which allows for simultaneous measurement of a specular component excluded (SCE) component and a specular component included (SCI) component to provide a correlated gloss value. The average gloss value may be obtained by placing a fabric on a neutral support and obtaining a gloss value for a number, e.g. 10, spots across the fabric and providing an average gloss value. In embodiments, the spectrophotometer (for example a Spectrophotometer X-Rite Ci7600), may be set up with the following settings: Geometry-D\8°-Tri-beam simultaneous SCE/SCI (SPEX/SPIN); Illumination-Pulsed Xenon, D65 Calibrated; and aperture diameter 25 mm. The average gloss value may be provided for a 25 mm diameter of a sample functionalized fabric.

### Fabric Stack

A fabric stack comprises at least two layers of a functionalized fabric as described herein.

In embodiments, a fabric stack comprises at least two layers of a functionalized fabric as described herein wherein one layer of functionalized fabric is directly disposed on another layer of functionalized fabric. In embodiments, the fabric stack comprises at least 3 layers of a functionalized fabric as described herein, for example at least 4 layers, at least 6 layers or at least 8 layers of a functionalized fabric as described herein. In embodiments, the fabric stack comprises up to 50 layers of a functionalized fabric as described herein, for example, up to 30 layers, up to 25 layers, up to 20 layers up to 15 layers, up to 10 layers of a functionalized fabric as described herein. In embodiments, the fabric stack comprises 2-50 layers of a functionalized fabric as described herein, for example 4-30 layers, or 6-25 layers of a functionalized fabric as described herein. In embodiments, the fabric stack comprises a plurality of layers of functionalized fabric as described herein, wherein the each of the plurality of layers of functionalized fabric is directly disposed on another of the plurality of layers of functionalized fabric.

In embodiments, the fabric stack comprises a plurality of layers of functionalized fabric as described herein, each of the plurality of layers of functionalized fabric being directly disposed on another of the plurality of layers of functionalized fabric, each of the plurality of layers of functionalized fabric having one surface on which binder (e.g. binder particles) is disposed and another surface which is substantially free of binder, wherein each of the plurality of functionalized fabrics is stacked such that surfaces of each of the plurality of functionalized fabrics on which the binder is disposed are directly disposed on a surface of another of the plurality of layers of functionalized fabric being substantially free of binder.

In embodiments, the layers of the fabric stack are adhered to one another. A fabric stack in which layers of the fabric stack are adhered to one another may be referred to herein as a “consolidated fabric stack”.

In embodiments, the layers of the fabric stack may be adhered to one another by a suitable treatment such as heating, curing, or exposure to UV radiation for example. In embodiments, the layers of the fabric stack may be adhered to one another by heating the fabric stack such that the binder particles of a first layer of functionalized fabric adhere the first layer of functionalized fabric to a second layer of functionalized fabric. In embodiments, the layers of the fabric stack may be adhered to one another by heating the fabric stack to a temperature greater than the glass transition temperature of the binder, for example to a temperature at least about 5° C. greater than the glass transition temperature of the binder, to a temperature at least about 10° C. greater than the glass transition temperature of the binder, or to a temperature at least about 15° C. greater than the glass transition temperature of the binder. In embodiments, the layers of the fabric stack may be adhered to one another by heating the fabric stack to a temperature greater than the softening temperature of the binder, for example to a temperature at least about 5° C. greater than the softening temperature, to a temperature at least about 10° C. greater than the softening temperature, or to a temperature at least about 15° C. greater than the softening temperature. In embodiments, the layers of the fabric stack may be adhered to one another by heating the fabric stack to a temperature greater than the melting temperature of the binder. In embodiments, the layers of the fabric stack may be adhered to one another by heating the fabric stack to a temperature of at least about 50° C., for example at least about 60° C., at least about 70° C., at least about 80° C., at least about 90° C., or at least about 100° C. In embodiments, the layers of the fabric stack may be adhered to one another by heating the fabric stack to a temperature of up to about 150° C., for example up to about 130° C., or up to about 120° C. In embodiments, the layers of the fabric stack may be adhered to one another by heating the fabric stack to a temperature in the range of about 50° C. to about 150° C., for example about 70° C. to about 130° C., or about 80° C. to about 120° C. In embodiments, the layers of the fabric stack may be adhered to one another by heating the fabric stack as described above for about 1 minute or more, for example up to about 1 hour, for example from about 1 to about 10 mins.

In embodiments, providing a consolidated fabric stack may comprise adhering the layers of the fabric stack to one another. In embodiments, the layers of the fabric stack may be adhered to one another by exposing the fabric stack to a temperature of up to about 150° C. and a pressure below atmospheric pressure, for example a pressure in the range of about 500 mbar to about 1000 mbar, or about 600 mbar to about 1000 mbar, about 700 mbar to about 1000 mbar, about 750 mbar to about 1000 mbar, about 800 mbar to about 1000 mbar, or about 900 mbar. In embodiments, the fabric stack is exposed to increased temperature (i.e. heated) and/or reduced pressure for a time period of up to about 5 hours, for example up to about 3 hours, up to about 2 hours or up to about 1 hour to form a consolidated fabric stack. In embodiments, the fabric stack is exposed to increased temperature (i.e. heated) and/or reduced pressure for a time period of at least about 10 mins, for example at least about 30 mins to form a consolidated fabric stack. In embodiments, the fabric stack is exposed to increased temperature (i.e. heated) and/or reduced pressure for a time period of about 10 mins to about 5 hours, for example about 30 mins to about 2 hours, or about 30 mins to about 1 hour to form a consolidated fabric stack.

In embodiments, the fabric stack or consolidated fabric stack described herein may be impregnated with a resin and the resin cured to form a composite article.

### Process for Producing a Functionalized Fabric

A process for producing a functionalized fabric may comprise:
providing a fiber fabric as described herein;
   applying binder particles having a glass transition temperature of up to about 75° C. to the fiber fabric; and adhering the binder particles to the fiber fabric to provide the functionalized fabric, wherein the binder is applied to the fiber fabric in an amount such that the binder constitutes up to about 5 wt. % of the functionalized fabric.

A process for producing a functionalized fabric may comprise:
providing a fiber fabric as described herein;
applying binder (e.g. binder particles) as described herein to the fiber fabric to provide the functionalized fabric, and
adhering the binder particles to the fiber fabric,
   wherein the binder is applied to the fiber fabric in an amount such that the binder constitutes up to about 5 wt. % of the functionalized fabric, and
wherein the functionalized fabric has a surface on which at least some of the binder is present having an average gloss value of about 65 G.U. or less.

In embodiments, the process comprises applying binder (e.g. binder particles) to the fiber fabric to provide a functionalized fabric having a binder distribution of up to about 30 g/m², for example up to about 20 g/m², up to about 25 g/m², up to about 18 g/m², up to about 16 g/m², up to about 15 g/m², or up to about 13 g/m². In embodiments, the process comprises applying the binder to the fiber fabric to provide a functionalized fabric having a binder distribution of at least about 2 g/m², for example at least about 4 g/m², at least about 5 g/m², at least about 7 g/m², at least about 8 g/m², or at least about 10 g/m². In embodiments, the process comprises applying the binder to the fiber fabric to provide a functionalized fabric having a binder distribution in the range of about 2 g/m² to about 30 g/m², for example about 4 g/m² to about 20 g/m², about 4 g/m² to about 15 g/m², about 7 g/m² to about 13 g/m², or about 10 g/m² to about 13 g/m².

In embodiments, the binder (e.g. binder particles) is applied to the fiber fabric in an amount such that the binder constitutes up to about 5 wt. % of the functionalized fabric. In embodiments, the binder constitutes up to about 5.0 wt. % of the functionalized fabric, for example up to about 4.5 wt. %, up to about 4.0 wt. %, or up to about 3.5 wt. % of the functionalized fabric. In embodiments, the binder constitutes at least about 0.1 wt. % of the functionalized fabric, for example at least about 0.2 wt. %, or at least about 0.3 wt. % of the functionalized fabric. In embodiments, the binder constitutes from about 0.1 wt. % to about 5.0 wt. % of the functionalized fabric, for example from about 0.1 wt. % to about 4.0 wt. %, or from about 0.2 wt. % to about 3.5 wt. % of the functionalized fabric.

In embodiments, binder is applied to a surface of the fiber fabric, for example by scattering the binder particles over the surface of the fiber fabric.

In embodiments, the binder is applied to the surface of fiber fabric as binder particles. The binder particles that are applied to the fiber fabric may have a volume average particle size of up to about 1 mm, for example up to about 800 μm, up to about 600 μm, up to about 500 μm, up to about 400 μm, up to about 300 μm, or up to about 200 μm. In embodiments, the binder particles that are applied to the fiber fabric have a volume average particle size of greater than about 10 μm, for example greater than about 20 μm, greater than about 30 μm, greater than about 40 μm, or greater than about 50 μm. In embodiments, the binder particles that are applied to the fiber fabric have a volume average particle size in the range of about 10 μm to about 1 mm, for example about 20 μm to about 600 μm, about 30 μm to about 500 μm, about 40 μm to about 400 μm, or about 50 μm to about 300 μm. The volume average particle size of the binder particles that are applied to the fiber fabric may be determined using a dynamic light scattering technique on a dispersion of the binder particles before application to the fiber fabric. A particle size analyzer such as a LS13320 Particle Size Analyzer from Beckman™ may be employed to determine the volume average particle size by laser diffraction following the ISO 13320 2009 norm (i.e. using a dynamic light scattering technique on a dispersion of the binder particles before being applied to the fiber fabric). The samples may be analyzed twice, as received, after dispersion in air and the sample quantity is typically around 20 g per test.

In embodiments, the binder (e.g. binder particles) may be adhered to the fiber fabric by a suitable treatment such as heating, curing, or exposure to UV radiation for example. In embodiments, the process comprises heating the functionalized fabric to adhere the binder to the fiber fabric. In embodiments, the process comprises heating the binder to adhere the binder to the fiber fabric. In embodiments, heating the binder/functionalized fabric to adhere the binder to the fiber fabric comprises heating the functionalized fabric to a temperature greater than the glass transition temperature of the binder, for example to a temperature at least about 5° C. greater than the glass transition temperature of the binder, to a temperature at least about 10° C. greater than the glass transition temperature of the binder, or to a temperature at least about 15° C. greater than the glass transition temperature of the binder. In embodiments, heating the binder/functionalized fabric to adhere the binder to the fiber fabric comprises heating the functionalized fabric to a temperature greater than the softening temperature of the binder, for example to a temperature at least about 5° C. greater than the softening temperature, to a temperature at least about 10° C. greater than the softening temperature, or to a temperature at least about 15° C. greater than the softening temperature. In embodiments, heating the binder/functionalized fabric to adhere the binder to the fiber fabric heating the functionalized fabric to a temperature greater than the melting temperature of the binder. In embodiments, heating the binder/functionalized fabric to adhere the binder to the fiber fabric comprises heating the functionalized fabric to a temperature of at least about 50° C., for example at least about 60° C., at least about 70° C., at least about 80° C., at least about 90° C., or at least about 100° C. In embodiments, heating the binder/functionalized fabric to adhere the binder to the fiber fabric comprises heating the functionalized fabric to a temperature of up to about 150° C., for example up to about 130° C., or up to about 120° C. In embodiments, heating the binder/functionalized fabric to adhere the binder to the fiber fabric comprises heating the functionalized fabric to a temperature in the range of about 50° C. to about 150° C., for example about 70° C. to about 130° C., or about 80° C. to about 120° C. In embodiments, heating the binder/functionalized fabric to adhere the binder to the fiber fabric comprises heating the functionalized fabric as described above for about 1 minute or more, for example up to about 1 hour, for example from about 1 to about 10 mins.

In embodiments, the binder particles adhered to the surface of the functionalized fabric have a size distribution such that at least 90% of the binder particles (by number of particles) adhered to a surface of the fiber fabric have a longest axial length of less than about 2 mm, for example, less than about 1 mm, less than about 800 μm, less than about 700 μm, less than about 600 μm, or less than about 500 μm. In embodiments, the binder particles adhered to the surface of the functionalized fabric have a size distribution such that at least 90% of the binder particles (by number of particles) adhered to the surface of the fiber fabric have a longest axial length of at least about 1 μm, at least about 10 μm, or at least about 20 μm. In embodiments, the binder particles adhered to the surface of the functionalized fabric have a size distribution such that at least 90% of the binder particles (by number of particles) adhered to the surface of the fiber fabric have a longest axial length in the range of about 1 μm to about 1 mm, for example in the range of about 1 μm to about 800 μm, about 10 μm to about 600 μm, or about 10 μm to about 500 μm. The binder particle size distribution can be determined as described herein.

In embodiments, for example in which the binder of the factionalized fabric is applied to the fiber fabric in the form of a dispersion comprising the binder or a solution comprising the binder, applying and/or adhering the binder to the fiber fabric may comprise evaporating a liquid component of the binder or solution comprising the binder.

### Shaped Component

A shaped component comprises a fabric stack (for example a consolidated fabric stack) as described herein.

A shaped component may be produced by:
a) providing a fabric stack as described herein;
b) shaping the fabric stack; and
c) heating the shaped stack at a temperature up to about 150° C.

In embodiments, shaping the fabric stack involves placing the fabric stack (for example a consolidated fabric stack) over or in a mold. In embodiments, shaping the fabric stack involves placing the fabric stack (for example a consolidated fabric stack) over or in a mold and applying increased heat and/or reduced pressure to the fabric stack.

In embodiments, providing the shaped component comprises shaping the fabric stack (for example a consolidated fabric stack) and heating the fabric stack (for example the consolidated fabric stack) at a temperature of at least about 50° C., for example at least about 60° C., at least about 70° C., at least about 80° C., at least about 90° C., or at least about 100° C. In embodiments, providing the shaped component comprises shaping the fabric stack (for example a consolidated fabric stack) and heating the fabric stack (for example the consolidated fabric stack) at a temperature of up to about 150° C., for example up to about 130° C., or up to about 120° C. In embodiments, providing the shaped component comprises shaping the fabric stack (for example a consolidated fabric stack) and heating the fabric stack (for example the consolidated fabric stack) at a temperature in the range of about 50° C. to about 150° C., for example about 70° C. to about 130° C., or about 80° C. to about 120° C.

In embodiments, producing a shaped component may comprise shaping the fabric stack and heating the fabric stack at a temperature up to about 150° C. and at a pressure below atmospheric pressure, for example a pressure in the range of about 500 mbar to about 1000 mbar, or about 600 mbar to about 1000 mbar, about 700 mbar to about 1000 mbar, about 750 mbar to about 1000 mbar, about 800 mbar to about 1000 mbar, or about 900 mbar.

In embodiments, the fabric stack is exposed to increased temperature (i.e. heated) and/or reduced pressure for a time period of up to about 5 hours, for example up to about 3 hours, up to about 2 hours or up to about 1 hour to form a shaped article. In embodiments, the fabric stack is exposed to increased temperature (i.e. heated) and/or reduced pressure for a time period of at least about 10 mins, for example at least about 30 mins to form a shaped article. In embodiments, the fabric stack is exposed to increased temperature (i.e. heated) and/or reduced pressure for a time period of about 10 mins to about 5 hours, for example about 30 mins to about 2 hours, or about 30 mins to about 1 hour.

In embodiments, the shaped component described herein may be impregnated with a resin and the resin cured to form a composite article.

In embodiments, the binder is selected to be compatible with the resin used to form a composite article. For example, epoxy compatible (e.g. epoxy based binder) binder may be selected in cases in which the functionalized fabric is to be incorporated into a composite article comprising an epoxy resin. For example, polyester compatible (e.g. polyester based binder) binder may be selected in cases in which the functionalized fabric is to be incorporated into a composite article comprising a polyester resin. The binder may be selected such that the binder is soluble in the resin used to form a composite article.

The functionalized fabrics described herein may be stacked in a manner which allows a plurality of fabric stacks to be connected/joined together. The way in which layers of functionalized fabrics are stacked can provide different joint types by which a plurality of fabric stacks may be connected/joined together. In an example, layers of functionalized fabric may be stacked directly on top of one another (i.e., with the edges of the functionalized fabric of each layer directly above one another) and two or more fabric stacks (e.g., consolidated fabric stacks) being joined together such that the edge of one fabric stack abuts the edge of a second fabric stack (a butt joint). In another example, layers of functionalized fabric may be stacked such that at least one (in some examples at least two or at least three layers of functionalized fabric) overlap a or each lower layer of functionalized fabric, two fabric stacks formed in this way may then be joined by a lap Joint. In another example, a plurality of functionalized fabric layers may be stacked to form a hole (mortise) in joining edge of the fabric stack and a joining fabric stack comprising a plurality of layers of functionalized fabric stacked to form a protrusion (tenon) in a joining edge of the fabric stack such that the protrusion of one fabric stacks fits into the hole of the other fabric stack (Mortise and Tenon Joint).

The tongue and groove connections described herein can be considered as being analogous to tongue and groove type joints that are commonly used in woodworking and construction. The concept involves creating a protruding tongue on one fabrics stack (e.g., consolidated fabric stack) and a corresponding groove or slot on another fabrics stack (e.g., consolidated fabric stack). When the two (or more) fabric stacks are assembled (i.e. connected/joined), the tongue fits snugly into the groove, creating a strong and secure joint that is resistant to twisting and pulling forces. The use of such tongue and groove connections between fabric stacks has been found to provide improvements in the assembly of composite articles formed from fabric stacks (including consolidated fabric stacks and shaped components) by reducing slipping of fabric stacks during assembly which also reduces wrinkling in the resulting composite article.

In embodiments, a fabric stack (the fabric stack may be a consolidated fabric stack or formed into a shaped component) comprises a plurality of functionalized fabric layers as described herein, wherein the plurality of functionalized fabric layers are stacked such that at least one edge of the fabric stack forms a groove configuration (female) or a tongue configuration (male).

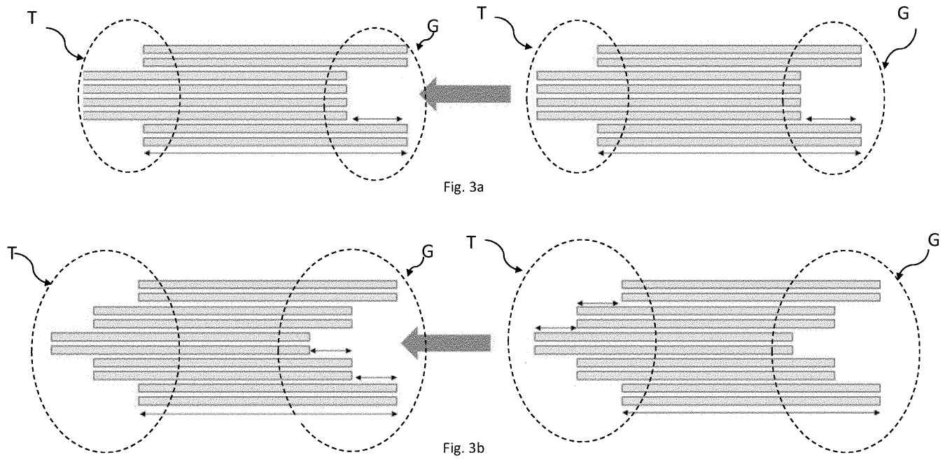

In embodiments, the fabric stack (the fabric stack may be a consolidated fabric stack or formed into a shaped component) comprises a plurality of functionalized fabric layers as described herein, wherein the plurality of functionalized fabric layers are stacked such that one edge of the fabric stack forms a groove configuration (female) and the opposed edge of the fabric stack forms a tongue configuration (male). FIGS. 3a and 3b show cross-sections through fabric stacks in which the plurality of functionalized fabric layers are stacked such that one edge of the fabric stack forms a groove “G” configuration (female) and the opposed edge of the fabric stack forms a tongue “T” configuration (male).

In embodiments, a kit of parts is provided comprising:
a fabric stack (the fabric stack may be a consolidated fabric stack or formed into a shaped component) comprising a plurality of functionalized fabric layers as described herein, wherein the plurality of functionalized fabric layers are stacked such that at least one edge of the fabric stack forms a groove configuration (female); and
a fabric stack (the fabric stack may be a consolidated fabric stack or formed into a shaped component) comprising a plurality of functionalized fabric layers as described herein, wherein the plurality of functionalized fabric layers are stacked such that at least one edge of the fabric stack forms a tongue configuration (male),
wherein the tongue configuration is configured to fit into the groove configuration.

A fabric stack (the fabric stack may be a consolidated fabric stack or formed into a shaped component as described herein) comprises a plurality of layers of functionalized fabric as described herein. A fabric stack (the fabric stack may be a consolidated fabric stack or formed into a shaped component as described herein) comprising layers stacked such that at least one edge of the fabric stack forms a groove configuration (female) or a tongue configuration (male) is formed from at least 3 layers of functionalized fabric. A fabric stack (the fabric stack may be a consolidated fabric stack or formed into a shaped component as described herein) comprising layers stacked such that at least one edge of the fabric stack forms a groove configuration (female) or a tongue configuration (male) can be considered to be formed of at least one top layer of functionalized fabric, at least one middle layer of functionalized fabric and at least one bottom layer of functionalised fabric. In embodiments, a fabric stack (the fabric stack may be a consolidated fabric stack or formed into a shaped component as described herein) comprising layers stacked such that at least one edge of the fabric stack forms a groove configuration (female) or a tongue configuration (male) can be considered to be formed of at least one top layer of functionalized fabric, a plurality of middle layers of functionalized fabric and at least one bottom layer of functionalised fabric. In embodiments, a fabric stack (the fabric stack may be a consolidated fabric stack or formed into a shaped component as described herein) comprising layers stacked such that at least one edge of the fabric stack forms a groove configuration (female) or a tongue configuration (male) can be considered to be formed of a plurality of top layers of functionalized fabric, a plurality of middle layers of functionalized fabric and a plurality of bottom layers of functionalised fabric. A “groove configuration” comprises a recess formed along one edge of the fabric stack, the recess or depression being formed by the position of the at least one middle layer of the functionalized fabric, or the plurality of middle layers of the functionalized fabric. An example of a groove configuration can be seen in FIGS. 3a and 3b, the groove configuration marked “G”. In embodiments, the “groove configuration” may be a stepped groove configuration formed by a plurality of middle layers of the fabric stack. An example of a stepped groove configuration can be seen in FIG. 3b, the stepped groove configuration marked “G”. A “tongue configuration” comprises a protrusion formed along one edge of the fabric stack, the protrusion being formed by the position of the at least one middle layer of the functionalized fabric, or the plurality of middle layers of the functionalized fabric. An example of a tongue configuration can be seen in FIGS. 3a and 3b, the tongue configuration marked “T”. In embodiments, the “tongue configuration” may be a stepped tongue configuration formed by a plurality of middle layers of the fabric stack. An example of a stepped tongue configuration can be seen in FIG. 3b, the stepped groove configuration marked “T”.

In embodiments, the groove (the recess formed by the position of the at least one middle layer of the functionalized fabric of the fabric stack or shaped component) is composed of at least two layers of functionalized fabric as defined herein, for example at least three layers of functionalized fabric, at least four layers of functionalized fabric, or five or more layers of functionalized fabric as defined herein.

In embodiments, the tongue (the protrusion formed by the position of the at least one middle layer of the functionalized fabric of the fabric stack or shaped component) is composed of at least two layers of functionalized fabric as defined herein, for example at least three layers of functionalized fabric, at least four layers of functionalized fabric as defined herein, or five or more layers of functionalized fabric as defined herein.

In embodiments, the middle layer of the functionalized fabric of the fabric stack (the layers of functionalized fabric of the fabric stack positioned to form the tongue and/or the groove configuration of the fabric stack) is formed from at least two layers of functionalized fabric, for example, at least three layers of functionalized fabric, at least four layers of functionalized fabric as defined herein, or five or more layers of functionalized fabric as defined herein. In embodiments, the middle layer of the functionalized fabric of the fabric stack is formed from 2-10 layers of functionalized fabric.

In embodiments, the top layer of the functionalized fabric of the fabric stack is formed from at least two layers of functionalized fabric, for example, at least three layers of functionalized fabric, at least four layers of functionalized fabric as defined herein, or five or more layers of functionalized fabric as defined herein. In embodiments, the top layer of the functionalized fabric of the fabric stack is formed from 2-5 layers of functionalized fabric.

In embodiments, the bottom layer of the functionalized fabric of the fabric stack is formed from at least two layers of functionalized fabric, for example, at least three layers of functionalized fabric, at least four layers of functionalized fabric as defined herein, or five or more layers of functionalized fabric as defined herein. In embodiments, the bottom layer of the functionalized fabric of the fabric stack is formed from 2-5 layers of functionalized fabric.

Also described herein is a process of forming a subcomponent article, for example a subcomponent for a wind turbine blade, comprising a fabric stack or a shaped component, the process including the steps of:
providing a plurality of functionalized fabric layers as described herein; and
stacking the plurality of functionalized fabric layers to form a first fabric stack edge having a groove configuration and a second fabric edge having a tongue configuration, wherein the second fabric stack edge opposes the first fabric stack edge.

Also described herein is a process for joining at least two fabric stacks or shaped components described herein, the process comprising:
providing a first fabric stack as described herein having a stack edge having a groove configuration and a second fabric stack as described herein having a stack edge having tongue configuration; and
positioning the first fabric stack and the second fabric stack in a mold adjacent to one another such that the tongue of the second fabric stack is inserted into the groove of the first fabric stack.

### Examples

The following illustrates examples of the fabrics and related aspects described herein. Thus, these examples should not be considered to restrict the present disclosure, but are merely in place to teach how to carry out the processes and obtain the products of the present disclosure.

Functionalized fabrics were produced by applying varying amounts of binder to one surface of different fiber fabrics. The materials used are described below and Table 1 summarises each of the functionalized fabrics of the examples.

### Fiber Fabrics Used in the Examples

All of the fiber fabrics used in the Examples were non-crimp fabrics and contained glass first fibers and glass second fibers, the first and second fibers being maintained in their respective orientations by a stitching yarn. The glass fibers making up the fiber fabrics included an epoxy compatible sizing.

Uni-directional fiber fabrics (denoted “UD” in the table below) used in these Examples contained second fibers (glass fibers) constituting up to about 5 wt. % of the fiber fabric, with first fibers (glass fibers) constituting at least 95 wt. % of the fiber fabric, the second direction being substantially perpendicular to the first direction. The uni-directional fabrics are referred to as “UDO” and “UD90”, UDO fabrics contain first fibers oriented in the 0 direction (i.e. aligned with the length of the fabric), UD90 fabrics contain first fibers oriented in the 90 direction (i.e. perpendicular to the length of the fabric).

Bi-axial fiber fabrics used in these Examples contained second fibers (glass fibers) constituting at least about 15 wt. % of the fiber fabric, the second direction being either substantially perpendicular to the first direction (these fabrics being denoted “BX90” in the table below) or around 45 degrees to the first direction (these fabrics being denoted “BX45” in the table below).

The inventors expect that other fiber fabrics described herein to provide functionalized fabrics providing similar advantages to the fiber fabrics employed in these Examples.

### Measurement Methods

The glass transition temperature of the binder was determined using differential scanning calorimetry (DSC) according to EN ISO 11357-2 (determination of glass transition temperature) heating the binder under an air flow of 80 mL/min at a heating rate of 10K/min, heating from −60 WO 2023/180423 36 PCT/EP2023/057418° C. to 120° C. and then holding for 5 mins at 120° C. before cooling from 120° C. to −60° C. at a cooling rate of 10K/min and then holding for 5 mins at −60° C. before heating from −60° C. to 120° C. again at a heating rate of 10K/min. The glass transition temperature was determined as the value provided on the second heating cycle.

The volume average particle size of the binder that were applied to the fiber fabrics described in the Examples that follow to provide functionalized fabrics were determined using a dynamic light scattering technique on a dispersion of the binder using a Particle size analyzer (LS13320 Particle Size Analyzer from Beckman™) and using a dynamic light scattering technique on a dispersion of the binder in accordance with ISO 13320 2009 norm.

The shear modulus, G, at 30° C. of the binder employed in the Examples that follow was determined using a oscillatory rheometer at 0.1% deformation in plan-plan geometry, a frequency of 1 Hz with a binder sample having a thickness of 400 μm and diameter of 25 mm, employing a heating-cooling-heating cycle which heats from 30° C.-130° C. at a heating rate of 3° C./min, cooling from 130° C.-30° C. and heating from 30° C.-130° C. at a heating rate of 3° C./min.

The dynamic viscosity, n, at 130° C. of the binder employed in the Examples that follow was determined using a oscillatory rheometer at 0.1% deformation in plan-plan geometry, a frequency of 1 Hz with a binder sample having a thickness of 400 μm and diameter of 25 mm, employing a heating-cooling-heating cycle which heats from 30° C.-130° C. at a heating rate of 3° C./min, cooling from 130° C.-30° C. and heating from 30° C.-130° C. at a heating rate of 3° C./min.

### Binders

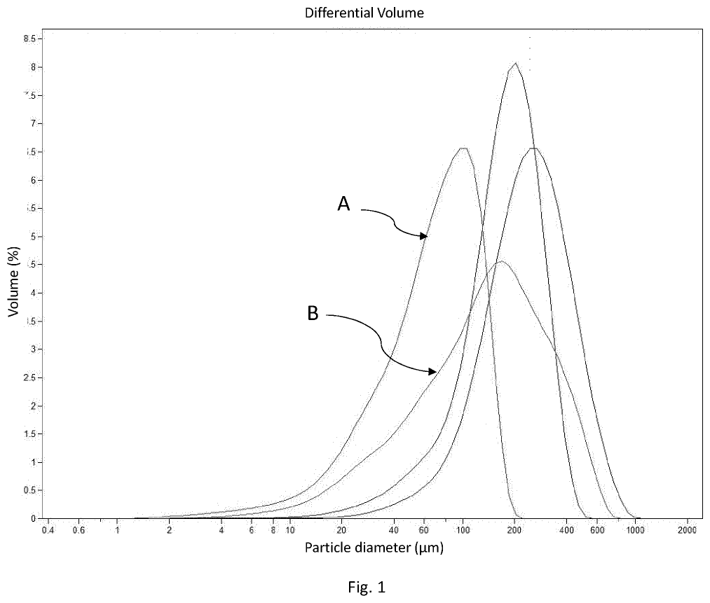

EP1—An epoxy based resin obtained from Hexion™ having a glass transition temperature of 58° C. (as determined using DSC as described above) and having a softening point of 72° C. which was determined using an oscillatory rheometer in accordance with the method described above, a volume average particle size of about 80 μm (determined using a dynamic light scattering technique by employing a Particle Size Analyzer (LS13320 from Beckman™), see also FIG. 1, line A), a shear modulus, G, at 30° C. of 11.5 MPa (determined using an oscillatory rheometer as set out above), a a dynamic viscosity, n, at 130° C. of 32.5 Pa·s (determined using an oscillatory rheometer as set out above), a molecular weight, Mw, of 5245 and a polydispersity of 2.83 (determined as Mw/Mn).

EP2—An epoxy based binder obtained from CTP™ having a glass transition temperature of 54° C. (as determined using DSC as described above) and a softening point of 69° C. which was determined using an oscillatory rheometer in accordance with the method described above, a volume average particle size of about 169 μm using DSC as described above, see also FIG. 1, line B), a shear modulus, G, at 30° C. of 18.4 MPa (determined using an oscillatory rheometer as set out above]), a dynamic viscosity, n, at 130° C. of 16.8 Pa·s (determined using an oscillatory rheometer as set out above), a molecular weight, Mw, of 4771 and a polydispersity of 2.83 (determined as Mw/Mn).

Polyester binder—polyester-based binder particles obtained from Coim™ having a glass transition temperature of 46° C. (determined using DSC as described above), and a softening point of 57° C. which was determined using an oscillatory rheometer in accordance with the method described above, a volume average particle size of about 185 μm determined using a dynamic light scattering technique by employing a Particle Size Analyzer (LS13320 from Beckman™), see also FIG. 1, line C), a shear modulus, G, at 30° C. of 30.7 MPa (determined using an oscillatory rheometer as set out above), a dynamic viscosity, n, at 130° C. of 387 Pa·s (determined using an oscillatory rheometer as set out above), a molecular weight, Mw, of 185710 and a polydispersity of 28.87 (determined as Mw/Mn)).

TABLE 1

| | | | | | Amount |
|---|---|---|---|---|---|
| | | Fiber | | | of binder |
| | | fabric | | Binder | particles by |
| | Fiber | areal | | particles | total weight of |
| | fabric | weight | Resin | distribution | functionalized |
| Example | type | (g/m²) | binder | (g/m²) | fabric (wt. %) |
| 1 | UD90 | 600 | EP1 | 7 | 1.2 |
| 2 | UD90 | 600 | EP1 | 13 | 2.2 |
| 3 | UD90 | 600 | EP1 | 20 | 3.3 |
| 4 | BX90 | 610 | EP1 | 13 | 2.1 |
| 5 | BX45 | 1000 | EP2 | 13 | 1.3 |
| 6 | UD0 | 1300 | EP2 | 4 | 0.3 |
| 7 | UD0 | 1300 | EP2 | 7 | 0.5 |
| 8 | UD0 | 1300 | EP2 | 13 | 1.0 |
| 9 | UD0 | 1300 | Polyester | 7 | 0.5 |
| 10 | UD0 | 1300 | Polyester | 13 | 1.0 |
| 11 | UD0 | 1300 | Polyester | 15 | 1.2 |
| 12 | UD0 | 600 | Polyester | 10 | 1.7 |

The functionalized fabrics of Examples 1-12 were provided by applying the resin binders in the amounts shown in Table 1 to the fiber fabrics described above and after application of the resin binders to the fiber fabrics heating to a temperature of 110° C. (a temperature greater than the melting temperature of each of the resin binders) for 1 minute and then cooled to room temperature to adhere the binder particles to the surface of the fiber fabrics. FIG. 2 shows an example of an image (taken using a 3D microscope) of the surface of a functionalized fabric as described herein in which the binder has been adhered to the surface of the fiber fabric by melting and solidification (by cooling) of the binder. It can be seen from FIG. 2 that the functionalized fabric comprises binder particles adhered to the surface of the fiber fabric (discrete binder particles) are spaced apart from one another, that is around each binder particle there is an area of the surface of the fiber fabric that is free from binder particles.

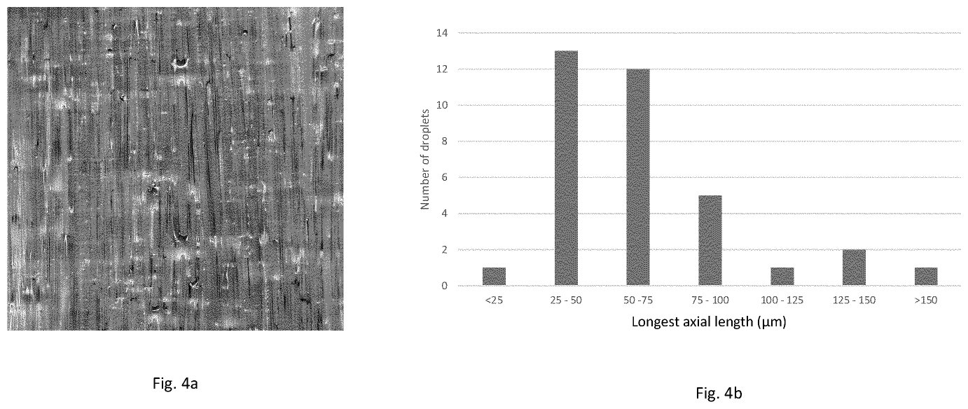

FIG. 4a shows an example of an image (taken using a 3D microscope) of the surface of the functionalized fabric produced according to Example 1. FIG. 4b is a graph showing the binder particle size distribution on the surface of the functionalized fabric shown in FIG. 4a. The binder particle size distribution, showing the range in longest axial length of each of the adhered binder particles, was determined using an optical microscope (Keyence™ optical miscroscope) and associated image analysis software (ImageJ software) to calculate the binder particle size distribution over a 5 mm² area of the functionalized fabric.

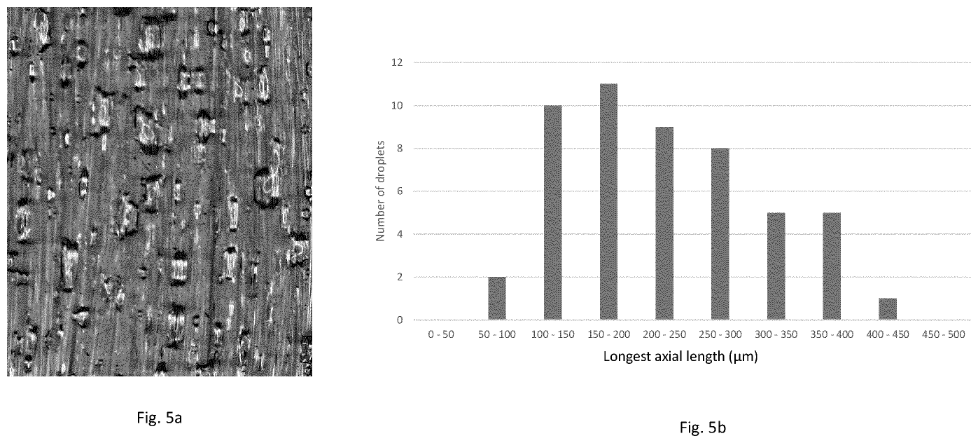

FIG. 5a shows an example of an image (taken using a 3D microscope) of the surface of the functionalized fabric produced according to Example 10. FIG. 5b is a graph showing the binder particle size distribution on the surface of the functionalized fabric shown in FIG. 5a. The binder particle size distribution, showing the range in longest axial length of each of the adhered binder particles, was determined using an optical microscope (Keyence™ optical miscroscope) and associated image analysis software (Image] software) to calculate the binder particle size distribution over a 10 mm² area of the functionalized fabric.

### Abrasion Test

The adhesion strength between the fiber fabric and the adhered binder particles of the functionalized fabric of Example 11 was determined using a scrub test (Elcometer 1720 Abrasion Tester) following ISO 11998-2006. The tests were performed without liquid with three abrasive materials: microfiber fabric, Scotch-Brite™ 7446 type pad and sandpaper 100 grade. The weight of the abrasive pad with holder is 455 g. Scrubbed surface is 300 mm. 200 runs (back and forth) were performed. For each of the functionalized fabrics tested the following results were obtained:

Scrub test with microfiber fabrics—no impact on binder adhesion and no weight loss. Slight visual change is noticed where abrasion of the fiber fabric occurred.

Scrub test with Scotch-Brite™ 7446 type pad—no impact on binder adhesion and no weight loss. Slight visual change is noticed where abrasion of the fiber fabric occurred.

Scrub test with sandpaper P100—The fabrics were destroyed. After only 5-10 runs fuzz starts to appear. The binder was found to be held within the fuzz glass. This indicates that the adhesion between the adhered binder particles and the fiber fabric is greater than the fiber fabric's resistance to abrasion.

Therefore, following these tests the present inventors have found that the binder particles adhered to the fiber fabrics of these functionalized fabrics are permanently adhered to the surface of the fiber fabric as the binder particles cannot be removed from the fiber fabrics by abrasion as described above.

The present inventors expect other functionalized fabrics described herein to show similar resistance to abrasion.

The functionalized fabrics of each of the Examples were found to handle extremely well, without shedding binder.

The functionalized fabrics were then formed into fabric stacks by stacking 5-20 layers, a different fabric stack formed for each of the functionalized fabrics of Examples 1-12.

Each type of fabric stack was then shaped using a mold and heated at reduced pressure of around 900 mBar for a time of around 30 mins to 1 hour. It was found that each of the fabric stacks was successfully consolidated to form a shaped component (i.e. a component taking the form of the mold even after removal from the mold) in this relatively short time period at temperatures ranging from 50-100° C., with temperatures around 100° C. providing the most defined shaped components.

Each of the shaped components formed form the different functionalized fabrics were then infused with epoxy or polyester resin. Shaped components containing functionalized fabrics comprising epoxy binder were infused with epoxy resin, shaped components containing functionalized fabrics comprising polyester binder were infused with polyester resin). Samples of each of the fiber fabrics used in Examples 1-12 to which binder had not been applied were also infused with epoxy/polyester resin for comparison (Reference Examples 1-12 respectively). The resin infused shaped components were cured to form composite articles.

The shaped components formed of the functionalized fabrics of Examples 1-12 were found to show excellent infusion speed, in fact showed faster infusion speed than the corresponding fiber fabrics without binder.

It was found that the mechanical performance (for example, shear and strength properties in the 0° (first direction), 45° and 90° directions) of the composite articles comprising the functionalized fabrics of Examples 1-12 were comparable to those of composite articles comprising corresponding fiber fabrics without the binder.

### Gloss Measurements

Gloss measurements were taken for a number of the functionalized fabrics produced according to the Examples and Reference Examples. Gloss measurements were taken using a Spectrophotometer X-Rite Ci7600 apparatus using the following settings:

Geometry: D\8°-Tri-beam simultaneous SCE/SCI (SPEX/SPIN)

Illumination: Pulsed Xenon, D65 Calibrated

Aperture diameter: 25 mm.

The spectrophotometer apparatus contains two ports, the Sample Viewing Port and the Specular Port. The Viewing Port contains the receiver and the light sensitive detectors that quantify the light reflecting from the sample's surface. The Specular Port can be opened or closed to control the type of measurement. If the port is open, the device will take a Specular Excluded (SPEX) reading to provide a specular component excluded (SCE) value to the gloss measurement. If the port is closed, the device will take a Specular Included (SPIN) reading to provide a specular component included (SCI) component to the gloss measurement. The ability to simultaneously measure SCI/SCE allows the calculation of a correlated gloss value linked to product appearance.

The gloss measurements of each of the samples tested was provided by placing the functionalized fabric samples or reference fabric samples on a neutral support (e.g. cardboard with double face adhesive tapes in order to avoid wrinkles and maintain the glass rovings aligned) with the surface to which the binder resin is adhered facing away from the support (i.e. towards the aperture of the spectrophotometer). The samples were then then clamped between the aperture and the sample holder. The samples were oriented such that the rovings constituting the warp of the fabrics were vertically oriented. Even for fabrics where the warp was 90° oriented compared to roll length, were placed with warp being vertically oriented. For each sample 10 random spots over the 25 mm diameter area were investigated, two measurements per spot were taken and an average of these values was provided. The results are provided in Table 2 below.

TABLE 2

| Functionalized fabric of Example | Average Gloss (G.U.) |
|---|---|
| 1 | 51.9 |
| 2 | 53.6 |
| 3 | 40.0 |
| 4 | 63.3 |
| 5 | 41.3 |
| 11 | 46.0 |
| Ref. 1-3 | 76.3 |
| Ref. 4 | 88.3 |
| Ref. 5 | 79.2 |
| Ref. 11 | 79.0 |

The results provided above demonstrate the lower average gloss values shown by the functionalized fabrics of the Examples compared to the reference fabrics. Without wishing to be bound by theory, the lower average gloss values is thought to result from the low amounts of binder employed in these functionalized fabrics leading to discrete areas of binder (e.g. distinct binder particles) on the surface of the functionalized fabric (for example, as opposed to a continuous layer of binder on the surface of the fabric).

The present inventors also produced and tested similar functionalized fabrics to those described above except using a range of other fiber fabrics described herein to provide functionalized fabrics. These additional functionalized fabrics were found to providing similar advantages to the fiber fabrics employed in these Examples.

Additionally, the inventors have found that the fabric stacks or shaped components described herein can be employed to remarkably improve lay-up speed of composite articles including the shaped components described herein. For example, shaped components comprising the functionalized fabrics described herein can be employed during wind turbine blade manufacture by incorporating a shaped component directly into a wind turbine blade during the lay-up procedure.

### Assembly of Functionalized Fabrics to Form Subcomponent Articles, Such as Subcomponents of Wind Turbine Blades

Two or more fabric stacks or shaped components as described above can be assembled to form a subcomponent article, for example a subcomponent of a wind turbine blade.

The present inventors have found that advantages can be provided by providing fabric stacks (the fabric stack may be a consolidated fabric stack or formed into a shaped component) comprising a plurality of functionalized fabric layers as described herein, wherein the plurality of functionalized fabric layers are stacked such that one edge of the fabric stack forms a groove configuration (female) and the opposed edge of the fabric stack forms a tongue configuration (male). FIGS. 3a and 3b show cross-sections through fabric stacks in which the plurality of functionalized fabric layers are stacked such that one edge of the fabric stack forms a groove “G” configuration (female) and the opposed edge of the fabric stack forms a tongue “T” configuration (male). The present inventors have found that by providing fabric stacks with such a tongue and groove configuration, such that adjacent fabric stacks can be slotted into one another, improvements in both assembly and the mechanical properties of the resulting subcomponent article are improved.

The present inventors have found that the tongue and groove arrangement address issues encountered during lay-up (compared to, for example, laying up fabric stacks which have been stacked with fabric layers aligned on top of one another or overlapping to form a stair configuration at opposing edges, for example by assembling using butt joints or lap joints as described above), such as slipping of fabric stacks and/or wrinkling of the fabric stacks.

The present inventors have also found that the tongue and groove arrangement described herein also improves mechanical strength of composite articles comprising subcomponent articles by reducing the size of “resin gaps” (i.e., a gap between fabric stacks that is filled with resin during the formation of a composite article due to gaps formed between adjacent fabric stacks).

Accordingly, the inventors having surprisingly found that fabric stacks having a tongue and groove configuration can be used to provide a subcomponent for a wind turbine blade with improved properties such as improved mechanical uniformity.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

If a standard test is mentioned herein, unless otherwise stated, the version of the test to be referred to is the most recent at the time of filing this patent application.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A functionalized fabric comprising:
a fiber fabric; and
a plurality of binder particles having a glass transition temperature of up to about 75° C.,
wherein the fiber fabric comprises:
a plurality of first fibers oriented in a first direction; and
a plurality of second fibers oriented in a second direction,
wherein the first fibers comprise as least one of glass fibers and carbon fibers,
wherein the second fibers comprise as least one of glass fibers and carbon fibers, and
wherein the second direction is within 0 degrees to 90 degrees of the first direction,
wherein the binder particles constitute up to about 5 wt. % of the functionalized fabric, and
wherein the binder particles are adhered to a surface of the fiber fabric.

2. The functionalized fabric according to claim 1, wherein the binder particles constitute from about 0.1 wt. % to about 3.5 wt. % of the functionalized fabric.

3. The functionalized fabric according to claim 1, wherein the functionalized fabric comprises from about 2 g/m² to about 20 g/m² of the binder particles.

4. The functionalized fabric according to claim 1, wherein the binder particles adhered to the surface of the functionalized fabric have a size distribution such that at least 90% of the binder particles, by total number of particles, adhered to the surface of the fiber fabric have a longest axial length of less than about 1 mm.

5. The functionalized fabric according to claim 1, wherein the binder particles adhered to the surface of the functionalized fabric have a size distribution such that at least 90% of the binder particles, by total number of particles, adhered to the surface of the fiber fabric have a longest axial length in the range of about 1 μm to about 1 mm.

6. The functionalized fabric according to claim 1, wherein the functionalized fabric has a surface on which at least some of the binder particles are present having an average gloss value of about 65 G.U. or less.

7. The functionalized fabric according to claim 1, wherein the functionalized fabric has a surface on which at least some of the binder particles are present having an average gloss value in the range of about 25 G.U. to about 60 G.U.

8. The functionalized fabric according to claim 1, wherein the fiber fabric is a unidirectional fiber fabric.

9. The functionalized fabric according to claim 1, the functionalized fabric having an areal weight in the range of about 500 g/m² to about 2500 g/m².

10. The functionalized fabric according to claim 1, wherein the binder particles comprise a thermoplastic binder.

11. The functionalized fabric according to claim 1, wherein the binder particles have a glass transition temperature in the range of about 40° C. to about 70° C.

12. The functionalized fabric according to claim 1, wherein the binder particles comprise at least one of epoxy, acrylate, and ester functional groups.

13. The functionalized fabric according to claim 1, wherein at least one of the first fibers and the second fibers are glass fibers.

14. The functionalized fabric according to claim 1, wherein the fiber fabric is a non-crimp fabric, wherein the functionalized fabric further comprises a stitching yarn, and wherein the stitching yarn maintains the first and second fibers in their respective orientations.

15. The functionalized fabric according to claim 1, wherein at least about 80 wt. % of the binder particles are disposed on one surface of the fiber fabric of the functionalized fabric.

16-17. (canceled)

18. A process for producing a functionalized fabric, the process comprising:
providing a fiber fabric comprising a plurality of first fibers oriented in a first direction and a plurality of second fibers oriented in a second direction, the first fibers comprising at least one of glass fibers and carbon fibers, the second fibers comprising at least one of glass fibers and carbon fibers, and the second direction being within 0 degrees to 90 degrees of the first direction;
applying a plurality of binder particles having a glass transition temperature of up to about 75° C. to the fiber fabric; and
adhering the binder particles to the fiber fabric to provide the functionalized fabric,
wherein the binder particles are applied to the fiber fabric in an amount such that the binder particles constitute up to about 5 wt. % of the functionalized fabric.

19. The process for producing a functionalized fabric according to claim 18, wherein adhering the binder particles to the fiber fabric comprises heating the functionalized fabric.

20. The process for producing a functionalized fabric according to claim 18, wherein the binder particles are applied to the fiber fabric and adhered to the fiber fabric such that the binder particles adhered to a surface of the functionalized fabric have a size distribution such that at least 90% of the binder particles, by total number of particles, adhered to the surface of the fiber fabric have a longest axial length in the range of about 1 μm to about 1 mm.

21. The process for producing a functionalized fabric according to claim 18, wherein the binder particles applied to the fiber fabric have a volume average particle size in the range of about 20 μm to about 600 μm.

22. The process for producing a functionalized fabric according to claim 18, wherein the functionalized fabric has a surface on which at least some of the binder particles are present having an average gloss value about 65 G.U. or less.

23-24. (canceled)
